(19) United States
(12) Patent Application Publication
(10) Pub. No.: US 2022/0316620 A1
(43) Pub. Date: Oct. 6, 2022

(54) STEAM VALVE

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Osamu SHINDO, Yokohama Kanagawa (JP); Miyako NIMORI, Yokohama Kanagawa (JP); Shunichi HORII, Yokohama Kanagawa (JP); Ryuhei TAKEMARU, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/667,637

(22) Filed: Feb. 9, 2022

(30) Foreign Application Priority Data
Apr. 1, 2021 (JP) 2021-062660

(51) Int. Cl. F16K 47/04; F16K 1/36; F16K 1/42

(52) U.S. Cl. CPC F16K 47/04; F16K 1/36; F16K 1/42; F01D 17/00

(57) ABSTRACT

In a steam valve of an embodiment, a valve element of a comprises: a first valve element part positioned in the closing direction, and including a first valve element part outer peripheral surface configured to surround the valve rod; and a second valve element part positioned in the opening direction, and including a second valve element part outer peripheral surface configured to surround the valve rod. The first valve element part outer peripheral surface is a curved surface formed to have a diameter increased toward the opening direction. A diameter of boundary position between the first valve element part outer peripheral surface and the second valve element part outer peripheral surface is the same as a seat diameter of valve seat at which the valve element is brought into contact with the valve seat when the steam valve is set to a fully-closed state.

### CROSS REFERENCE TO RELATED APPLICATIONS

This application is based upon and claims the benefit of priority from the prior Japanese Patent Application (No. 2021-062660), filed on Apr. 1, 2021; the entire contents of which are incorporated herein by reference.

### FIELD

Embodiments of the present invention relate to a steam valve.

### BACKGROUND

In a steam turbine configuring a steam turbine power generation plant, a steam valve is installed at an inlet of the steam turbine. The steam valve is configured to regulate a flow rate of steam by changing an area of a flow path between a valve element and a valve seat in a valve chamber of a valve casing.

In the steam valve, high-pressure steam flows, so that vibration is generated due to a drift, a vortex, or the like, which sometimes causes breakage such as a crack to the valve element or a valve rod.

Particularly, in a steam valve such as a steam control valve installed on an upstream side of a high-pressure turbine or an intercept valve installed on an upstream side of an intermediate-pressure turbine, there is a case where a state of steam which flows between a valve element and a valve seat becomes a transonic state, which generates a shock wave. Accordingly, the flow is disturbed by the shock wave, resulting in that the above-described problem sometimes becomes obvious.

For this reason, in order to prevent the generation of vibration of a steam valve device, various techniques have been proposed.

However, in the prior art, it has not been easy to sufficiently reduce the vibration of the steam valve device. For example, there is a case where, due to an oxide scale adhered to a portion, of a surface of a valve element, positioned on an upstream side of a seat dimeter portion of valve seat at which the valve element and the valve seat are brought into contact with each other, and an influence of surface roughness during manufacture, a flow is disturbed at the seat diameter portion of valve seat, which generates vibration.

Therefore, a problem to be solved by the present invention is to provide a steam valve capable of effectively preventing the generation of vibration.

### BRIEF DESCRIPTION OF THE DRAWINGS

FIG. 1 is a view schematically illustrating a steam turbine plant according to a first embodiment.

FIG. 2 is a sectional view illustrating one example of a configuration of a steam valve according to the first embodiment.

FIG. 3 is a sectional view illustrating, in an enlarged manner, a part of a valve seat 314 and a valve element 321 in the steam valve according to the first embodiment.

FIG. 4 is a sectional view illustrating, in an enlarged manner, a part of a valve seat 314 and a valve element 321 in a steam valve according to a second embodiment.

FIG. 5 is a sectional view illustrating, in an enlarged manner, a part of a valve seat 314 and a valve element 321 in a steam valve according to a third embodiment.

### DETAILED DESCRIPTION

A steam valve, comprising: a valve seat installed in a valve casing; and a valve element coupled to a valve rod in the valve casing, and moving along an axial direction of the valve rod. A distance between the valve element and the valve seat is reduced when the valve rod moves in a closing direction in which the steam valve is closed. The distance between the valve element and the valve seat is increased when the valve rod moves in an opening direction in which the steam valve is opened. The valve element comprises: a first valve element part positioned in the closing direction, and including a first valve element part outer peripheral surface configured to surround the valve rod; and a second valve element part positioned in the opening direction, and including a second valve element part outer peripheral surface configured to surround the valve rod. The first valve element part outer peripheral surface is a curved surface formed to have a diameter increased toward the opening direction. A diameter of boundary position between the first valve element part outer peripheral surface and the second valve element part outer peripheral surface is the same as a seat diameter of valve seat at which the valve element is brought into contact with the valve seat when the steam valve is set to a fully-closed state.

### First Embodiment

[A] Configuration of Steam Turbine Power Generation Plant

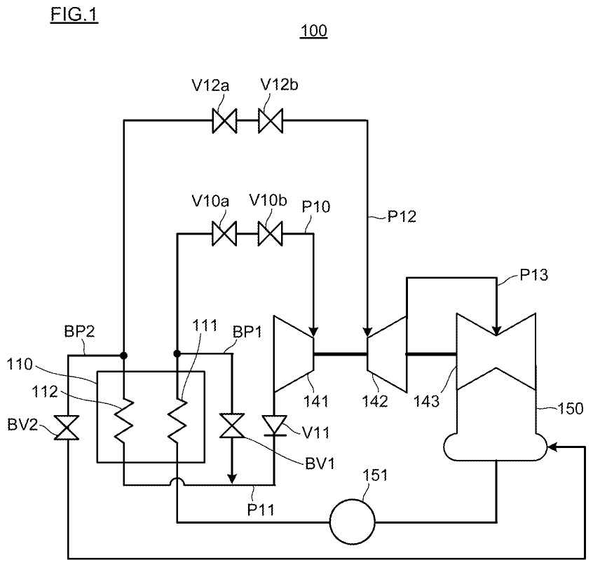

FIG. 1 is a view schematically illustrating a steam turbine plant according to a first embodiment.

As illustrated in FIG. 1, in a steam turbine power generation plant 100 of the present embodiment, steam heated by a superheater 111 of a boiler 110 is introduced into a high-pressure turbine 141 as a working fluid, via a main steam pipe P10 in which a main steam stop valve V10a and a steam control valve V10b are installed, and performs work in the high-pressure turbine 141. Subsequently, the steam discharged from the high-pressure turbine 141 passes through a low-temperature reheat steam pipe P11 in which a check valve V11 is installed, to be supplied to a reheater 112 of the boiler 110, and is heated again in the reheater 112.

The steam heated by the reheater 112 is introduced into an intermediate-pressure turbine 142 as a working fluid, via a high-temperature reheat steam pipe P12 in which a reheated steam stop valve V12a and an intercept valve V12b are installed, and performs work in the intermediate-pressure turbine 142. Subsequently, the steam discharged from the intermediate-pressure turbine 142 is introduced into a low-pressure turbine 143 as a working fluid, via a crossover pipe P13, and performs work in the low-pressure turbine 143. Subsequently, the steam discharged from the low-pressure turbine 143 is condensed by a condenser 150.

The water (condensed water) condensed by the condenser 150 is pressurized by a feed pump 151. The water (feedwater) pressurized by the feed pump 151 is returned to the superheater 111 of the boiler 110.

In the steam turbine power generation plant 100, a turbine rotor is coupled between the high-pressure turbine 141 and the intermediate-pressure turbine 142, and a turbine rotor is coupled between the intermediate-pressure turbine 142 and the low-pressure turbine 143, and the turbine rotors are rotated by the work of steam. Further, by the rotation of the turbine rotors, a power generator (illustration thereof is omitted) is driven, to thereby perform electrical power generation.

Note that in the steam turbine power generation plant 100, in order to enable to perform a circulating operation only by a system of the boiler 110, regardless of the operation of the turbines, there are provided a high-pressure turbine bypass pipe BP1 in which a high-pressure turbine bypass valve BV1 is installed, and a low-pressure turbine bypass pipe BP2 in which a low-pressure turbine bypass valve BV2 is installed. The high-pressure turbine bypass pipe BP1 has one end connected to the main steam pipe P10 at a part positioned on an upstream side of the main steam stop valve V10a, and has the other end connected to the low-temperature reheat steam pipe P11 at a part positioned on a downstream side of the check valve V11. The low-pressure turbine bypass pipe BP2 has one end connected to the high-temperature reheat steam pipe P12 at a part positioned on an upstream side of the reheated steam stop valve V12a, and has the other end connected to the condenser 150.

[B] Configuration of Steam Valve

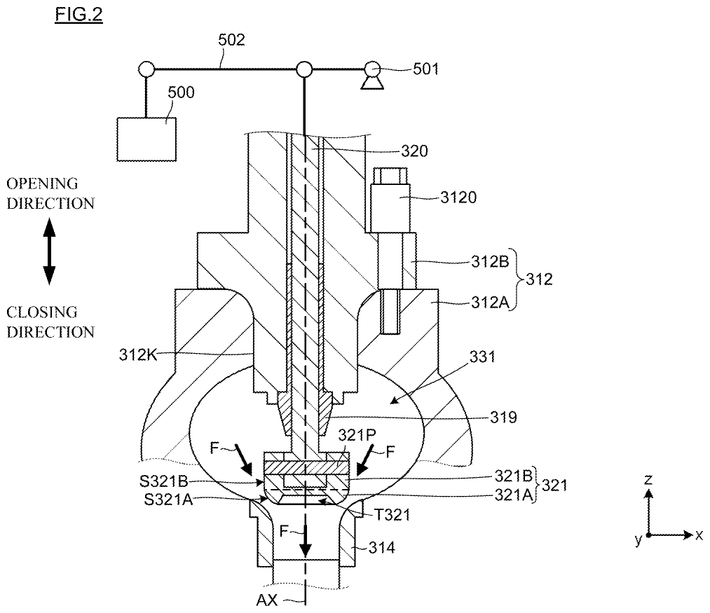

FIG. 2 is a sectional view illustrating one example of a configuration of the steam valve according to the first embodiment. In FIG. 2, a longitudinal direction is a vertical direction z, a lateral direction is a first horizontal direction x, and a direction perpendicular to the paper sheet is a second horizontal direction y which is orthogonal to the vertical direction z and the first horizontal direction x. FIG. 2 illustrates a vertical plane along the vertical direction z and the first horizontal direction x (xz plane). Further, FIG. 2 illustrates a state in which the steam valve has an arbitrary opening degree.

As illustrated in FIG. 2, in the steam valve of the present embodiment, a valve seat 314, and a valve element 321 installed on one end of a valve rod 320, are accommodated in a valve chamber 331 of a valve casing 312. When closing the steam valve, the valve rod 320 moves together with the valve element 321 in a closing direction being a downward direction in the vertical direction z, resulting in that a distance between the valve element 321 and the valve seat 314 is reduced. When opening the steam valve, the valve rod 320 moves together with the valve element 321 in an opening direction being an upward direction in the vertical direction z, resulting in that the distance between the valve element 321 and the valve seat 314 is increased.

The steam valve is, for example, the steam control valve V10b installed at an inlet of the high-pressure turbine 141 (steam turbine). The intercept valve V12b installed at an inlet of the intermediate-pressure turbine 142 (steam turbine) may also be configured in a similar manner (refer to FIG. 1).

The respective parts configuring the steam valve of the present embodiment will be described in order.

[B-1] Valve Casing 312

As illustrated in FIG. 2, in the steam valve, the valve casing 312 includes a first valve casing part 312A and a second valve casing part 312B.

In the valve casing 312, the first valve casing part 312A has a valve chamber 331 formed inside thereof. Although illustration is omitted, the valve chamber 331 is communicated with an inflow port through which steam F flows in, and is communicated with an outflow port from which the steam F flows out. Further, the first valve casing part 312A has an opening 312K formed above the valve chamber 331 in the vertical direction z.

In the valve casing 312, the second valve casing part 312B is positioned above the first valve casing part 312A in the vertical direction z, and blocks the opening 312K of the first valve casing part 312A. The second valve casing part 312B is fixed to the first valve casing part 312A by using a bolt 3120.

[B-2] Valve Rod 320

In the steam valve, the valve rod 320 is, for example, a cylindrical rod-shaped body, and its center axis AX is along the vertical direction z. The valve rod 320 is inserted into a bush 319 so as to be able to move in the vertical direction z, and penetrates the second valve casing part 312B.

[B-3] Valve Seat 314

In the steam valve, the valve seat 314 is installed in the valve chamber 331. The valve seat 314 is, for example, a ring-shaped tubular body, and is fixed to the first valve casing part 312A so as to be arranged in an axisymmetric manner with respect to the center axis AX of the valve rod 320 and in a coaxial manner with respect to the valve rod 320 in the valve chamber 331. A detailed configuration of the valve seat 314 will be described later.

[B-4] Valve Element 321

In the steam valve, the valve element 321 is accommodated in the valve chamber 331. The valve element 321 has a disk shape, for example, and is axisymmetric with respect to the center axis AX of the valve rod 320. The valve element 321 is coaxially coupled to one end (lower end) of the valve rod 320 inside the valve chamber 331 by using a pin 321P, for example. Further, the valve element 321 is installed so as to be able to move in the vertical direction z (axial direction) along the center axis AX of the valve rod 320. A detailed configuration of the valve element 321 will be described later together with the valve seat 314.

[B-5] Others

In addition to the above-described configuration, in the steam valve, an upper end portion of the valve rod 320 is coupled to an oil cylinder 500 via a lever 502. One end of the lever 502 is supported at a fulcrum 501, and by an operation of the oil cylinder 500, the valve rod 320 moves along the vertical direction z. Consequently, in the steam valve, the distance between the valve element 321 and the valve seat 314 varies to adjust an opening degree, which controls a flow of steam.

Concretely, the oil cylinder 500 moves the valve rod 320 in the closing direction in which the steam valve is closed in the vertical direction z, resulting in that the distance between the valve element 321 and the valve seat 314 reduces. Consequently, a flow rate of the steam F which passes between the valve element 321 and the valve seat 314 in the steam valve reduces.

Further, the oil cylinder 500 moves the valve rod 320 in the opening direction in which the steam valve is opened in the vertical direction z, resulting in that the distance between the valve element 321 and the valve seat 314 increases. Consequently, the flow rate of the steam F which passes between the valve element 321 and the valve seat 314 in the steam valve increases.

[C] Detailed Configuration of Valve Element 321

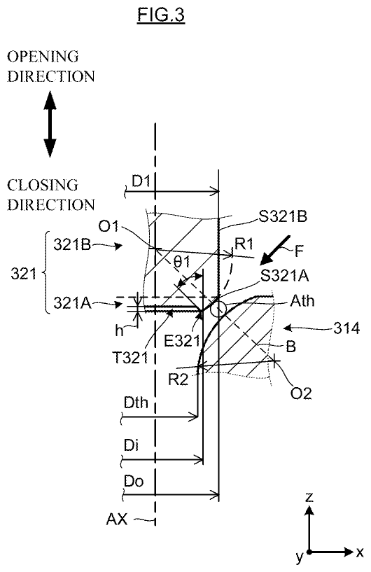

A detailed configuration of the valve element 321 will be described by using FIG. 3 together with FIG. 2.

FIG. 3 is a sectional view illustrating, in an enlarged manner, a part of the valve seat 314 and the valve element 321 in the steam valve according to the first embodiment. FIG. 3 illustrates, in a similar manner to FIG. 2, the vertical plane along the vertical direction z and the first horizontal direction x (xz plane).

In the present embodiment, the valve element 321 includes a first valve element part 321A and a second valve element part 321B, as illustrated in FIG. 2 and FIG. 3. In the valve element 321, the first valve element part 321A is a part positioned on a side of the closing direction (lower side) in which the steam valve is closed in the vertical direction z (axial direction). The second valve element part 321B is a part positioned on a side of the opening direction in which the steam valve is opened in the vertical direction z.

The first valve element part 321A includes a first valve element part outer peripheral surface S321A which surrounds a periphery of the valve rod 320 in the axial direction. The first valve element part outer peripheral surface S321A is a curved surface formed to have a diameter which is increased from one end in the closing direction (lower end) toward the other end in the opening direction (upper end). Concretely, the first valve element part outer peripheral surface S321A has an arc shape with a radius of curvature of R1 in which a center of curvature O1 positioned on a line of the center axis AX is set as a center.

The second valve element part 321B includes a second valve element part outer peripheral surface S321B which surrounds a periphery of the valve rod 320 in the axial direction. The second valve element part outer peripheral surface 321B has a shape different from that of the first valve element part outer peripheral surface S321A, and is configured to include a surface along the vertical direction z (axial direction) from one end in the closing direction (lower end) toward the other end (upper end). Concretely, the second valve element part outer peripheral surface S321B has a cylindrical shape which is axisymmetric with respect to the center axis AX.

In the present embodiment, a diameter D1 of the first valve element part outer peripheral surface S321A on the other end side in the opening direction (upper end side) and a diameter D1 of the second valve element part outer peripheral surface S321B on the one end side in the closing direction (lower end side) coincide with each other, and are the same as a seat diameter of valve seat Do at which the valve element 321 is brought into contact with the valve seat 314 when the steam valve is set to a fully-closed state. Specifically, in the valve element 321, the diameter D1 at the boundary position between the first valve element part 321A and the second valve element part 321B corresponds to the seat diameter of valve seat Do, and there is a corner.

[D] Regarding Recessed Portion T321

In the present embodiment, at a surface of the first valve element part 321A of the valve element 321, positioned on the side of the opening direction in the vertical direction z (axial direction) (lower surface in the drawing), a recessed portion T321 is formed. The recessed portion T321 has an orthogonal surface orthogonal to the vertical direction z (axial direction) (xy plane), and an inclined surface extended, in an inclined manner, from a periphery of the orthogonal surface to the side of the closing direction, and the inclined surface includes an edge E321 on the side of the closing direction. The flow of the steam F which flows along the curved surface of the first valve element part 321A is cut off by the edge E321 of the recessed portion T321.

In FIG. 3, h indicates a depth (height) of the recessed portion T321 of the valve element 321. θ1 is an inclination angle at which the inclined surface of the recessed portion T321 is inclined with respect to the vertical direction z (axial direction), and is 45°, for example. Di is a diameter of the edge E321. Dth is an inside diameter of the valve seat 314 which is in contact with a radius of curvature R2 of the valve seat 314. O1 is a center of curvature of the first valve element part outer peripheral surface S321A configured to have the radius of curvature R1 in the first valve element part 321A. O2 is a center of curvature of the curved surface configured to have the radius of curvature R2 in the valve seat 314. B is a major axis line connecting the center of curvature O1 of the first valve element part 321A and the center of curvature O2 of the valve seat 314.

In FIG. 3, Ath is the minimum steam passage area, and schematically illustrates the minimum value of the area of the steam passage through which the steam F passes, at a position between the valve seat 314 and the valve element 321, when the steam valve has an arbitrary opening degree. The area of the steam passage through which the steam F passes, at the position between the valve seat 314 and the valve element 321, reduces until when it reaches the minimum steam passage area Ath, along the flow of the steam F. After that, the area of the steam passage through which the steam F passes, at the position between the valve seat 314 and the valve element 321, increases from the minimum steam passage area Ath, along the flow of the steam F.

The minimum steam passage area Ath has a shape of truncated cone with the major axis line B set as a generatrix, and can be calculated from a radius of the valve element 321, a radius of the valve seat 314, and a height of the truncated cone, based on a general formula. According to a pressure distribution line (illustration is omitted) of an isoentropic flow in an ideal state when the steam passage formed of the valve seat 314 and the valve element 321 is replaced with a Laval nozzle, when a pressure ratio of a steam pressure P2 on an outlet side of the valve element 321 to a steam pressure P1 on an inlet side of the valve element 321 (P2/P1) is reduced, the pressure reaches a critical pressure at the minimum steam passage area Ath on the major axis line B. In the steam passage through which the steam F passes, at the position between the valve seat 314 and the valve element 321, the flow of the steam F from the inlet side to the minimum steam passage area Ath becomes a subcritical flow (subsonic flow). When the steam pressure P2 on the outlet side of the valve element 321 is further reduced, the flow of the steam F becomes a supercritical flow (supersonic flow). Generally, when the flow of the steam F becomes the supercritical flow, a shock wave is generated in a direction perpendicular to the steam flow, which raises the pressure. The flow of the pressure-raised steam cannot maintain a stable state by itself, and thus an unstable state is created in which noise and vibration are generated.

By taking such a fluid characteristic into consideration, in the present embodiment, the edge E321 of the recessed portion T321 is provided on an upstream side of a position at which the steam flowing along the valve element 321 separates, of the steam passage through which the steam F passes, at the position between the valve seat 314 and the valve element 321. Consequently, the flow of the steam F becomes the subcritical flow (subsonic flow) which does not generate the shock wave, and a stable flow is maintained, and thus it is possible to further suppress the generation of noise and vibration.

Concretely, when relations to be expressed by the following expressions regarding the respective parts are satisfied, it is possible to more effectively suppress the generation of noise and vibration.

Di≥0.90 Do Expression (1)

Dth≥0.80 Do Expression (2)

0.52 Do≤R1≤0.6 Do Expression (3)

R2≥0.6 Do Expression (4)

As described above, the state of the steam passage, formed of the valve seat 314 and the valve element 321, through which the steam F passes, is very sensitive, and thus it is clear that an influence thereof to be exerted on the fluid characteristic is large.

Here, a shape of a conventional valve element 321 will be described with reference to FIG. 3.

A first valve element part 321A includes a first valve element part outer peripheral surface S321A which surrounds the periphery of the valve rod 320 in the axial direction. The first valve element part outer peripheral surface S321A is a curved surface formed to have a diameter which is increased from one end in the closing direction (lower end) toward the other end in the opening direction (upper end). Concretely, the first valve element part outer peripheral surface S321A has an arc shape with the radius of curvature of R1 in which the center of curvature O1 positioned on a line of the center axis AX is set as a center. The arc portion of the first valve element part outer peripheral surface S321A passes through a position corresponding to the seat diameter of valve seat Do at which the valve element 321 is brought into contact with the valve seat 314 when the steam valve is set to a fully-closed state, and reaches a position corresponding to a diameter which is double the radius of curvature R1 (Dx, for example) toward the other end in the opening direction (upper end) (a shape indicated by a dotted line in FIG. 3).

A second valve element part 321B includes a second valve element part outer peripheral surface S321B which surrounds the periphery of the valve rod 320 in the axial direction. The second valve element part outer peripheral surface 321B has a shape different from that of the first valve element part outer peripheral surface S321A, and is configured to include a surface along the vertical direction z (axial direction) from one end in the closing direction (lower end) toward the other end (upper end). Concretely, the second valve element part outer peripheral surface S321B has a cylindrical shape which is axisymmetric with respect to the center axis AX. A diameter of this second valve element part outer peripheral surface S321B is a diameter of double the radius of curvature R1 (Dx, for example).

Specifically, regarding the shape of the conventional valve element 321, the diameter of the first valve element part outer peripheral surface S321A on the other end side in the opening direction (upper end side) and the diameter of the second valve element part outer peripheral surface S321B on the one end side in the closing direction (lower end side) (Dx, for example) coincide with each other, but are larger than the seat diameter of valve seat Do at which the valve element 321 is brought into contact with the valve seat 314 when the steam valve is set to a fully-closed state, and in the valve element 321, the first valve element part 321A and the second valve element part 321B are connected at a boundary position at which a tangent to a diameter thereof (Dx, for example) corresponds to a tangent to the radius of curvature R1, and thus there is no corner.

However, as described above, in the conventional steam valve, on the surface of the steam passage up to the second valve element part outer peripheral surface S321B including the first valve element part outer peripheral surface S321A on the upstream side of the seat diameter of valve seat Do, namely, on the inlet side, adhesion of oxide scale (slight convex shape) due to operation over time, and erosion (slight concave shape) due to a foreign matter flying during operation are likely to occur (the surface of the steam passage is likely to be slightly coarse). For this reason, in the conventional steam valve, even if there is provided the edge E321 on the side of the closing direction of the valve element 321 positioned on the downstream side of the steam passage, the slight convex and concave state on the surface of the steam passage positioned on the inlet side, first disturbs, at the inlet, the flow of the steam F when it passes through the passage. Consequently, this may lead to a generation of unnecessary shock wave in the middle of the passage of the steam F, which is a problem in the prior art.

In the present embodiment, on the upstream side of the seat diameter of valve seat Do at which the valve element 321 is brought into contact with the valve seat 314 in a fully-closed state, the valve chamber 331 with a large space is provided, which means there exists no steam passage, and thus the adhesion of oxide scale and the erosion do not occur physically. Therefore, the present embodiment can suppress the disturbance of the flow of steam, and thus it is possible to effectively prevent the generation of noise and vibration. In addition to that, since there is provided the edge E321 on the side of the closing direction of the valve element 321 positioned on the downstream side of the steam passage, the steam F can maintain a stable flow which does not generate a shock wave, and thus it is possible to further suppress the generation of noise and vibration.

### Second Embodiment

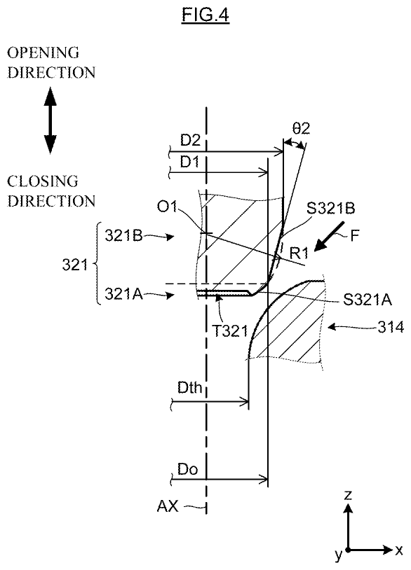

FIG. 4 is a sectional view illustrating, in an enlarged manner, a part of a valve seat 314 and a valve element 321 in a steam valve according to a second embodiment. FIG. 4 illustrates, in a similar manner to FIG. 3, the vertical plane along the vertical direction z and the first horizontal direction x (xz plane).

As illustrated in FIG. 4, in the valve element 321 of the present embodiment, the diameter D1 of the first valve element part outer peripheral surface S321A on the other end side in the opening direction (upper end side) and the diameter D1 of the second valve element part outer peripheral surface S321B on the one end side in the closing direction (lower end side) are the same as the seat diameter of valve seat Do, in a similar manner to the first embodiment (refer to FIG. 3). However, in the valve element 321 of the present embodiment, the shape of the second valve element part outer peripheral surface S321B is different from that of the first embodiment. Except for this point and points related thereto, the present embodiment is similar to the first embodiment. For this reason, explanation of overlapped matters will be appropriately omitted.

As illustrated in FIG. 4, in the present embodiment, the second valve element part outer peripheral surface S321B of the valve element 321 includes a tapered surface formed to have a diameter which is increased from the one end positioned on the side of the closing direction (lower end) toward the opening direction. In the second valve element part outer peripheral surface S321B, the diameter of the tapered surface changes at a constant rate from the diameter D1 to a diameter D2 toward the opening direction (D1<D2). The diameter D2 is preferably two times or less the radius of curvature R1 of the first valve element part outer peripheral surface S321A (D2≤2·R1). Further, an inclination angle θ2 at which the tapered surface is inclined with respect to the center axis AX of the valve rod 320, is preferably 6° or less for smoothly introducing steam into the steam passage, formed of the valve seat 314 and the valve element 321, through which the steam F passes (θ2<6°).

Further, a portion of the second valve element part outer peripheral surface S321B of the valve element 321, positioned further on the side of the opening direction than the tapered surface in the vertical direction z, is configured by a surface along the vertical direction z (axial direction).

As described above, in the steam valve of the present embodiment, the diameter D1 at the boundary position between the first valve element part 321A and the second valve element part 321B of the valve element 321, is the same as the seat diameter of valve seat Do, in a similar manner to the first embodiment. For this reason, in the present embodiment, on the upstream side of the seat diameter of valve seat Do at which the valve element 321 is brought into contact with the valve seat 314 in a fully-closed state, the valve chamber 331 with a large space is provided, which means there exists no steam passage, and thus the adhesion of oxide scale and the erosion do not occur physically. Therefore, the present embodiment can suppress the disturbance of the flow of steam, and not only that, since the second valve element part outer peripheral surface S321B of the valve element 321 includes the tapered surface as described above, the steam is smoothly introduced into the steam passage, formed of the valve seat 314 and the valve element 321, through which the steam F passes, which can effectively prevent the generation of noise and vibration. In addition to that, since there is provided the edge E321 on the side of the closing direction of the valve element 321 positioned on the downstream side of the steam passage, the steam F can maintain a stable flow which does not generate a shock wave, and thus it is possible to further suppress the generation of noise and vibration.

### Third Embodiment

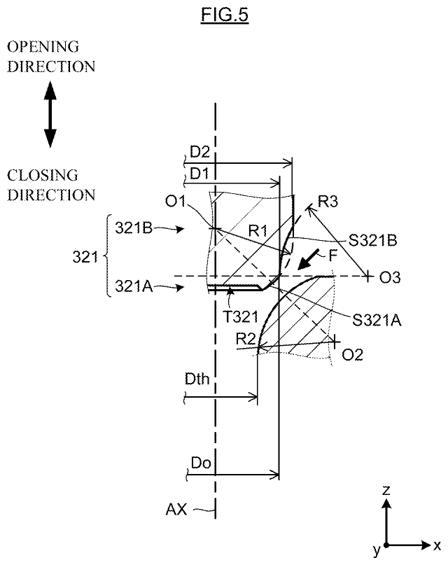

FIG. 5 is a sectional view illustrating, in an enlarged manner, a part of a valve seat 314 and a valve element 321 in a steam valve according to a third embodiment. FIG. 5 illustrates, in a similar manner to FIG. 3, the vertical plane along the vertical direction z and the first horizontal direction x (xz plane).

As illustrated in FIG. 5, in the valve element 321 of the present embodiment, the diameter D1 of the first valve element part outer peripheral surface S321A on the other end side in the opening direction (upper end side) and the diameter D1 of the second valve element part outer peripheral surface S321B on the one end side in the closing direction (lower end side) are the same as the seat diameter of valve seat Do, in a similar manner to the first embodiment (refer to FIG. 3). However, in the valve element 321 of the present embodiment, the shape of the second valve element part outer peripheral surface S321B is different from that of the first embodiment. Except for this point and points related thereto, the present embodiment is similar to the first embodiment. For this reason, explanation of overlapped matters will be appropriately omitted.

As illustrated in FIG. 5, in the present embodiment, the second valve element part outer peripheral surface S321B of the valve element 321 includes a bell-mouth curved surface formed to have a diameter which is increased from one end positioned on the side of the closing direction (lower end) toward the opening direction. In the second valve element part outer peripheral surface S321B, the diameter of the bell-mouth curved surface changes so as to draw a bell-mouth curve from the diameter D1 to a diameter D2 toward the opening direction (D1<D2). A center of curvature O3 of the bell-mouth curved surface of the second valve element part outer peripheral surface S321B is at a position corresponding to the boundary position between the first valve element part 321A and the second valve element part 321B in the vertical direction z (the position of the seat diameter of valve seat Do). The outer peripheral surface including the bell-mouth curved surface of the valve element 321 is axisymmetric with respect to the center axis AX of the valve rod 320. Here, the diameter D2 is preferably two times or less the radius of curvature R1 of the first valve element part outer peripheral surface S321A (D2≤2·R1). Further, a radius of curvature R3 of the bell-mouth curved surface is preferably equal to or less than the radius of curvature R2 of the valve seat 314 as long as the bell-mouth curved surface does not form a steam throttle part whose area is smaller than the minimum steam passage area Ath (R3≤R2). Note that regarding the bell-mouth curved surface in the second valve element part outer peripheral surface S321B, the diameter D1 on the closing direction side and the diameter D2 on the opening direction side may also be the same (namely, D1≤D2).

Further, a portion of the second valve element part outer peripheral surface S321B of the valve element 321, positioned further on the side of the opening direction than the bell-mouth curved surface in the vertical direction z, is configured by a surface along the vertical direction z (axial direction).

As described above, in the steam valve of the present embodiment, the diameter D1 at the boundary position between the first valve element part 321A and the second valve element part 321B of the valve element 321, is the same as the seat diameter of valve seat Do, in a similar manner to the first embodiment. For this reason, in the present embodiment, on the upstream side of the seat diameter of valve seat Do at which the valve element 321 is brought into contact with the valve seat 314 in a fully-closed state, the valve chamber 331 with a large space is provided, which means there exists no steam passage, and thus the adhesion of oxide scale and the erosion do not occur physically. Therefore, the present embodiment can suppress the disturbance of the flow of steam. Further, in the present embodiment, since the second valve element part outer peripheral surface S321B of the valve element 321 includes the bell-mouth curved surface as described above, the steam is smoothly introduced into the steam passage, formed of the valve seat 314 and the valve element 321, through which the steam F passes, which can effectively prevent the generation of noise and vibration. In addition to that, in the present embodiment, since there is provided the edge E321 on the side of the closing direction of the valve element 321 positioned on the downstream side of the steam passage, the steam F can maintain a stable flow which does not generate a shock wave, and thus it is possible to further suppress the generation of noise and vibration.

### Others

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

100: steam turbine power generation plant, 110: boiler, 111: superheater, 112: reheater, 141: high-pressure turbine, 142: intermediate-pressure turbine, 143: low-pressure turbine, 150: condenser, 151: feed pump, 312: valve casing, 312A: first valve casing part, 312B: second valve casing part, 312K: opening, 314: valve seat, 319: bush, 320: valve rod, 321: valve element, 321A: first valve element part, 321B: second valve element part, 321P: pin, 331: valve chamber, 500: oil cylinder, 501: fulcrum, 502: lever, 3120: bolt, Ath: minimum steam passage area, AX: center axis, B: major axis line, BP1: high-pressure turbine bypass pipe, BP2: low-pressure turbine bypass pipe, BV1: high-pressure turbine bypass valve, BV2: low-pressure turbine bypass valve, D1: diameter, D2: diameter, Do: seat diameter of valve seat, E321: edge, F: steam, O1: center of curvature, O2: center of curvature, O3: center of curvature, P10: main steam pipe, P11: low-temperature reheat steam pipe, P12: high-temperature reheat steam pipe, P13: crossover pipe, R1: radius of curvature, R2: radius of curvature, R3: radius of curvature, S321A: valve element part outer peripheral surface, S321B: valve element part outer peripheral surface, T321: recessed portion, V10a: main steam stop valve, V10b: steam control valve, V11: check valve, V12a: reheated steam stop valve, V12b: intercept valve, x: first horizontal direction, y: second horizontal direction, z: vertical direction

What is claimed is:

1. A steam valve, comprising:
a valve seat installed in a valve casing; and
a valve element coupled to a valve rod in the valve casing, and moving along an axial direction of the valve rod, in which a distance between the valve element and the valve seat is reduced when the valve rod moves in a closing direction in which the steam valve is closed, and the distance between the valve element and the valve seat is increased when the valve rod moves in an opening direction in which the steam valve is opened, wherein
the valve element comprises:
a first valve element part positioned in the closing direction, and including a first valve element part outer peripheral surface configured to surround the valve rod; and
a second valve element part positioned in the opening direction, and including a second valve element part outer peripheral surface configured to surround the valve rod, wherein:
the first valve element part outer peripheral surface is a curved surface formed to have a diameter increased toward the opening direction; and
a diameter of boundary position between the first valve element part outer peripheral surface and the second valve element part outer peripheral surface is the same as a seat diameter of valve seat at which the valve element is brought into contact with the valve seat when the steam valve is set to a fully-closed state.

2. The steam valve according to claim 1, wherein
the second valve element part outer peripheral surface includes a surface along the axial direction.

3. The steam valve according to claim 1, wherein
the second valve element part outer peripheral surface includes a tapered surface formed to have a diameter increased toward the opening direction.

4. The steam valve according to claim 1, wherein
the second valve element part outer peripheral surface includes a bell-mouth curved surface formed to have a diameter increased toward the opening direction.

5. The steam valve according to claim 1, wherein
the first valve element part includes a recessed portion formed on a surface on the side of the opening direction.
